(19) United States
(12) Patent Application Publication
(10) Pub. No.: US 2016/0081328 A1
(43) Pub. Date: Mar. 24, 2016

(54) Solutions for Red Blood Cells

(71) Applicant: PRESIDENT AND FELLOWS OF HARVARD COLLEGE, Cambridge, MA (US)

(72) Inventor: Hemant Thatte, Medfield, MA (US)

(21) Appl. No.: 14/890,254

(22) PCT Filed: May 12, 2014
(86) PCT No.: PCT/US14/37742

§ 371 Date: Nov. 10, 2015

Related U.S. Application Data
(60) Provisional application No. 61/822,003, filed on May 10, 2013.
(60) Provisional application No. 61/834,977, filed on Jun. 14, 2013.

(51) Int. Cl. A01N 1/02; A61J 1/10

(52) U.S. Cl. CPC A01N 1/0226; A61J 1/10

(57) ABSTRACT

The invention provides compositions and methods for rejuvenating expired banked RBC making them eligible for transfusion (as well as extending the shelf life of a red blood cell) by contacting the cell with a composition comprising (or consisting of) a physiological salt solution and a compound that increases ATP and 2,3-diphosphoglycerate (DPG) and nitric oxide in the cell or a compound that preserves cell deformability.

### CROSS REFERENCE TO RELATED APPLICATIONS

This application claims priority to and benefit of U.S. Provisional Application No. 61/822,003 filed on May 10, 2013 and U.S. Provisional Application No. 61/834,977 filed on Jun. 14, 2013; the contents of which are incorporated herein by reference in their entirety.

### GOVERNMENT SUPPORT

This invention was made with Government support under Department of Veterans Affairs Merit Review Grant, Grant No. N00014-09-1-0028 awarded by DoD/ONR and Harvard Royalties. The Government has certain rights in the invention.

### FIELD OF THE INVENTION

The invention relates to cell storage.

### BACKGROUND OF THE INVENTION

Red blood cells (RBC) are the most widely transfused blood component throughout the world. At present, the protocol for the storage of RBC (for up to 42 days) is the collection of blood into anticoagulant solutions (ACD (acid, citrate, dextrose, a.k.a., anti-coagulant, citrate, dextrose) or CPDA-1 (citrate phosphate dextrose adenine). The packed red cells are generally stored at 4° C.±2° C.

An increased rate of morbidity and mortality is associated with the transfusion of “older” RBC, e.g., those cells approaching the standard 42 day shelf life of stored RBC, because of development of storage lesions. Progressive loss in ATP, 2,3 DPG and nitric oxide (NO) and decreased deformability of RBC membranes impairs RBC function of oxygen delivery and vasodilatation.

### SUMMARY OF THE INVENTION

The invention provides a solution to the problems and drawbacks associated with present storage solutions and/or conditions. Accordingly, the invention provides compositions and methods for rejuvenating expired banked RBC making them eligible for transfusion (as well as extending the shelf life of a fresh i.e., newly drawn, red blood cell) by contacting the cell with a physiologically-acceptable salt solution, e.g., an aqueous salt solution that preserves the integrity of eukaryotic cells such as erythrocytes and further contains elements that preserve or replenish NO. For example, the composition comprising (or consisting of) a synthetic physiological salt solution and a compound that increases nitric oxide in the cell, increases ATP, increases 2,3-diphosphoglycerate (DPG) and/or a compound that preserves cell deformability. The solution and method are useful for RBC of any blood type (A, B, AB and O and other), positive or negative for the Rh factor, to extend their functional half-life. Exemplary synthetic solutions for blood cells termed “AMRUT” and RASA are described herein.

A key element of the synthetic solution is a compound (or compounds) that serves as a substrate for the enzyme, nitric oxide synthase (NOS). Examples include L-arginine and L-citrulline and/or salts or derivatives thereof. Nitric oxide (NO) is synthesized from L-arginine by the enzyme NOS. The reaction involves the transfer of electrons from NADPH, via the flavins FAD and FMN in the carboxy-terminal reductase domain, to the heme in the amino-terminal oxygenase domain, where the substrate L-arginine is oxidised to L-citrulline and NO. Other ingredients may also be present in the composition, e.g., ascorbic acid, which increases transport of L-arginine and/or L-citrulline into RBC. NOS is important for vasodilatation as well as prevention of clot formation (by inhibiting platelet activation) and preventing intimal hyperplasia.

Another element of the synthetic solution is a compound that increases 2,3 DPG. In preferred embodiments, the compound comprises a pentose sugar. For example, the pentose sugar is selected from the group consisting of Ribose, Xylose, Arabinose, Ribulose, or Xylulose. Compounds such as pentose sugars that increase and/or preserve 2,3, DPG levels in the RBC and increases their oxygen-carrying capacity.

The solution optionally also contains adenosine and/or adenine (a component of adenosine triphosphate (ATP).

The synthetic physiological salt solution portion of the composition/solution comprises Calcium chloride, Potassium chloride, Potassium phosphate, Magnesium chloride, Magnesium sulfate (e.g., heptahydrate), Sodium chloride, Sodium bicarbonate, and Sodium phosphate. Other ingredients include D-Glucose, Glutathione (e.g., reduced), and/or Ascorbic acid. For example, the formulation comprises the following ingredients/compounds:

Compounds

Calcium chloride
Potassium chloride
Potassium phosphate (e.g., monobasic)
Magnesium chloride (e.g., hexahydrate)
Magnesium sulfate (e.g., heptahydrate)
Sodium chloride
Sodium bicarbonate
Sodium phosphate (e.g., dibasic; heptahydrate)
D-Glucose
Glutathione (e.g., reduced)
Ascorbic acid
L-Arginine or a salt thereof
Adenosine
Ribose
L-Citrulline or a salt thereof

An exemplary solution comprises the following ranges of concentrations of ingredients. One example is called AMRUT and comprises the following ingredients/concentrations.

| COMPOUND | AMRUT gm/L | | Ranges | |
|---|---|---|---|---|
| Calcium chloride | (0.01 mM) | 0.0015 | 0-1.3 | mM |
| Potassium chloride | | | 0-4.5 | mM |
| Potassium phosphate | (0.44 mM) | 0.06 | 0.1-1.00 | mM |
| (e.g., monobasic) | | | | |
| Magnesium chloride | (0.5 mM) | 0.102 | 0-1 | mM |
| (e.g., Hexahydrate) | | | | |
| Magnesium sulfate | (0.5 mM) | 0.123 | 0-1 | mM |
| (e.g., Heptahydrate) | | | | |
| Sodium chloride | (100.0 mM) | 5.844 | 0-140 | mM |
| Sodium bicarbonate | (35.0 mM) | 2.941 | 5-50 | mM |
| Sodium phosphate | (10.0 mM) | 2.679 | 1-25 | mM |
| (e.g., dibasic; heptahydrate) | | | | |
| D-dextrose or glucose | (108.0 mM) | 19.457 | 50-200 | mM |
| Glutathione (e.g., reduced) | (0.50 mM) | 0.153 | 0-5 | mM |
| Ascorbic Acid | (1.70 mM) | 0.31 | 0-5 | mM |
| L-Arginine (or a salt thereof) | (3.00 mM) | 0.525 | 0-5 | mM |
| Adenine | (1.50 mM) | 0.204 | 1-5 | mM |
| Adenosine | (7.00 mM) | 1.869 | 1-10 | mM |
| L-citrulline (or a salt thereof) | (8.00 mM) | 1.401 | 0-10 | mM |
| Ribose | (21.0 mM) | 3.152 | 5-25 | mM |
| Mannitol | | | 0-50 | mM |

| | |
|---|---|
| Distilled water | to 1 L |
| pH | adjust to 7.8, if needed |

In this example and others described herein, the solution is made up as described above, and then adjusted to pH 7.8, e.g., using THAM or Sodium bicarbonate or Sodium hydroxide. Mannitol and Potassium chloride are optional.

The solution can be used with fresh or aged RBC, e.g., mix 50 ml RBC+50 ml solution.

The method comprises contacting RBC with the solution at or after day 42 of storage, day 21 of storage, day 8 of storage, day 1 of storage, or upon removal of the RBC from a living subject, e.g., within 1 minute to 24 hours after collection from a living subject. Contacting cells at any time after collection of the cells improves their physical and functional state and extends the functional half-life of the cells. The AMRUT composition/solution reduces the non-functionality, morbidity and eventual mortality associated with aging and expired blood in the eventuality of transfusion. Thus, countless more patients can benefit from this precious commodity than is presently possible.

Compounds used in the formulation are purified and/or isolated. Purified compounds are at least 60% by weight (dry weight) the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis. Purified also defines a degree of sterility that is safe for administration to a human subject, e.g., lacking infectious or toxic agents.

The salts described herein represent a means to introduce an active ingredient such as Arginine or Citrulline into the solution. As described below, a variety of salts are available and useful. Similarly, salts are used to introduce ions into the solution, e.g., to introduce Ca++ ions, the compound calcium chloride is listed; however, other salts such as calcium gluconate can be used to accomplish the same goal.

In some cases, RBC are processed. They are enriched for RBC by filtration and/or centrifugation to remove other cells that are present in whole blood in its naturally-occurring state when it is collected from a living human subject or non-human animal. For example, the population RBC are leukocyte-depleted. For example, the cells are about 55-65% RBC 55-65%, less than 5×10⁶ leukocytes per unit of packed red blood cells (pRBC) (FDA). Generally, pRBC are platelet free. Storage in the solution inhibits the development of echinocytes from the normal, healthy discocyte morphology of the cells and prevention in loss of energy and preservation of oxygen carrying capacity.

The transitional term “comprising,” which is synonymous with “including,” “containing,” or “characterized by,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Also with the invention are compositions and methods for storage and preservation of whole blood and/or red blood cells. The compositions/solutions of the present invention provide significantly extended long-term storage of fresh whole blood and/or fresh RBC. The present invention provides solutions and methods for the storage of whole blood or packed red blood cells for greater than 42 days. The solution and method are useful for whole blood or RBC of any blood type (A, B, AB and O and other), positive or negative for the Rh factor, extending the functional half-life. An exemplary solution termed “RASA” is described herein and represents an improvement over existing blood storage solutions.

For example, the composition comprises the following ingredients/compounds:

Compounds

Sodium phosphate, e.g., sodium phosphate (monobasic)
Glucose, e.g., D-Glucose
Glutathione, e.g., Glutathione (reduced)
Ascorbic acid
Arginine, e.g., L-Arginine or a salt thereof
Citric Acid
Sodium citrate
Adenine
Adenosine
Ribose
Citrulline, e.g., L-Citrulline or a salt thereof

Optionally, the composition may also comprise potassium phosphate e.g., potassium phosphate (monobasic); magnesium sulfate, e.g., magnesium sulfate (heptahydrate); sodium bicarbonate, and/or mannitol.

For example, the composition comprises the following ingredients/concentrations:

| Compounds | gm/L |
|---|---|
| Potassium phosphate (monobasic) | 0.0-1.00 |
| Magnesium sulfate (heptahydrate) | 0.0-0.20 |
| Sodium bicarbonate | 0.0-5.00 |
| Sodium phosphate (monobasic) | 2.20 |
| D-Glucose | 10.0-32.0 |
| Glutathione (reduced) | 0.09-0.20 |
| Ascorbic acid | 0.31-0.65 |
| L-Arginine | 0.21-0.84 |
| Citric Acid | 3.30 |
| Sodium citrate | 26.30 |
| Adenine | 0.028 |
| Adenosine | 1.0-5.00 |
| Ribose | 1.5-7.50 |
| L-Citrulline | 0.44-1.76 |
| Mannitol | 0.0-8.00 |

An exemplary solution is called RASA and comprises the following ingredients/concentrations:

| Compounds | gm/L |
|---|---|
| Potassium phosphate (monobasic) | 0.50 |
| Magnesium sulfate (heptahydrate) | 0.10 |
| Sodium bicarbonate | 3.11 |
| Sodium phosphate (monobasic) | 2.20 |
| D-Glucose | 18.00 |
| Glutathione (reduced) | 0.09 |
| Ascorbic acid | 0.31 |
| L-Arginine | 0.422 |
| Citric Acid | 3.30 |
| Sodium citrate | 26.30 |
| Adenine | 0.028 |
| Adenosine | 1.370 |
| Ribose | 3.15 |
| L-Citrulline | 0.88 |
| Mannitol | 3.83 |

For RASA, potassium ions and magnesium ions (e.g., as provided by potassium phosphate and magnesium sulfate are optional).

Collecting fresh whole blood or fresh RBC in the RASA composition/solution preserves physical and functional state of the blood components and extends the functional half-life of the cells. The RASA composition/solution reduces the non-functionality, morbidity and eventual mortality associated with aging and expired blood in the eventuality of transfusion. Thus, countless more patients can benefit from this precious commodity than is presently possible.

The solutions and methods of the present invention are suitable for the preservation and storage of whole blood (i.e. freshly drawn from a subject) or packed RBC (pRBC). In some embodiments, the RBC are processed. They are enriched for RBC by filtration and/or centrifugation to remove other cells that are present in whole blood in its naturally-occurring state when it is collected from a living human subject or non-human animal. For example, the packed RBC are leukocyte-depleted. For example, the cells are about 55-65% RBC 55-65%, less than 5×10⁶ leukocytes per unit of packed red blood cells (pRBC) (FDA). Generally, pRBC are platelet free. Storage in the solution inhibits the development of echinocytes from the normal, healthy discocyte morphology of the cells and prevention in loss of energy and preservation of oxygen carrying capacity.

RASA provides electrolytes, nitric oxide substrates, antioxidants, free radical scavengers, nucleotide and alternative energy source (Ribose) which are not present in CPDA-1 or other variants used in current practice. RASA facilitates preservation of blood in optimal condition, minimizing storage lesions in RBC, and facilitates direct transfusion without requiring a wash out of the components. Additionally, the components of RASA may provide improved vasodialation, and energy source for the patient along with improved hemoglobin (Hb) and increased hematocrit. Thus RASA provides multifactorial benefits in a patient requiring transfusion.

Also within the invention is a method for preparing RBC by providing whole blood drawn from a living animal such as a human patient, separating RBC from whole blood to form packed RBC, and adding a solution such as those described above to the cells to form a suspension. Accordingly, the invention encompasses a composition that comprises processed or fractionated RBC suspended in the solutions described herein, e.g., AMRUT or RASA. A method for storing RBC is carried out by adding an anti-coagulant to whole blood, holding the blood for about 4 to about 24-26 hours, separating the RBC from the remaining components in the above-described mixture, and adding the separated RBC to a storage and/or preservation solution described herein (or adding the solution to the separated RBC). A product for storing RBC includes a container, e.g. a bag, made of a polymeric material, e.g., plasticized polyvinyl chloride, polyethylene, or other suitable polymer, and a volume of a solution, e.g., AMRUT or RASA, contained within the bag with connections adapted to receive blood being drawn from an individual. The volume of solution in the bag depends on the volume of blood to be collected. For example, the ratio of RASA:Whole Blood ranges from 1:4 to 1:7.

The exemplary solutions are optionally used in a two-step method for processing freshly drawn blood This strategy is a two bag system: RASA+AMRUT with the first bag containing RASA or a derivative thereof as defined by ranges provided and a second bag containing AMRUT or a derivative thereof as defined by the ranges provided. A kit comprising the two-bag system and instructions for use is also within the invention. For example, whole blood is drawn and stored into RASA, then blood in RASA is leukocyte depleted and fractionated into RBC, Plasma and platelets or RBC and platelet rich plasma. The resulting fractionated or enriched RBC are then stored into Amrut for greater than 42 days. The method therefore comprises the steps of collecting blood in RASA, fractionating whole blood to obtain packed RBC or enriched RBC, and then transferring the resulting RBC into AMRUT, where they are stored any length of time including for over 42 days, e.g., 50, 60, 70, or more days. Alternatively, fractionated RBC are stored in RASA for any length of time including 42 or more day storage period.

A significant advantage of the solutions described herein, e.g., AMRUT for rejuvenation of old blood or RBC as well as storage of fresh blood or RBC and RASA for storage of fresh blood or RBC is the ability to preserve and/or replish NO. Arginine [e.g., L-arginine or a pharmaceutically-acceptable salt thereof such as L-arginine hydrochloride; Arginine alpha-ketoglutarate; L-arginine malate; L-Arginine L-pyroglutamate, also known as pirglutargine and arginine pidolate; NG-Monomethyl-L-arginine, monoacetate salt (L-NMMA)] and/or citrulline (e.g., L-citrulline or a pharmaceutically acceptable salt thereof such as citrulline malate, citrulline α-ketoglutarate, citrulline citrate or citrulline α-ketoisocaproate).

AMRUT also ameliorates “storage lesions” and rejuvenates expired banked RBC into biochemically functional state. Amrut will impede wastage of a very precious commodity, and help in recovery of rare blood groups (e.g., O^{-ve}) that can then be used for transfusion. RASA extends the shelf-life storage time of freshly drawn RBC. In addition, freshly drawn human RBC have been shown to be preserved in “storage lesion” free state in AMRUT for over 70 days (current standard is 42 days). RBC stored/preserved or rejuvenated according to the invention facilitate attenuation of extensive morbidity (and mortality) observed in transfused patients. The unique composition, and performance of AMRUT and RASA makes them superior to current technologies used in preservation of human RBC in “storage lesion” free state. Not only are the solutions useful for preservation/storage, they are also useful as a resuscitation/volume replacement solution.

Other features and advantages of the invention will be apparent from the following description of the preferred embodiments thereof, and from the claims. All references cited herein are hereby incorporated by reference.

### BRIEF DESCRIPTION OF THE DRAWINGS

FIGS. 1A-C are photographs showing restoration of RBC morphology after contact of cells with rejuvenation solution. A) Control RBC—Discocytes; B) Expired RBC—Echinocytes; C) Rejuvenated RBC—Discocytes.

FIG. 2 is a line graph showing morphological transformation of Blood Group O. RBC were 30 days past expiration (72 days). RBC stored in AMRUT transformed back into discocytes but not those in GALA, within 30 min and remained so throughout the storage period.

FIG. 3 is a line graph showing morphological transformation of Blood Group AB. RBC were 30 days past expiration (72 days). RBC stored in AMRUT transformed back into discocytes but not those in GALA, within 30 min and remained so throughout the storage period.

FIG. 4 is a bar graph showing hemoglobin restoration/retention by rejuvenated RBC. Mg protein/0.5 ml RBC on y axis. Expired blood group “O” RBC (72 days old) were incubated with various solutions for 90 min at 37° C. Total protein was estimated using standard Bradford protein assay. There is a significant increase in protein retention in RBC stored in AMRUT but in those stored in HBSS and GALA.

FIG. 5 is a bar graph showing hemoglobin restoration/retention by rejuvenated RBC. Mg protein/0.5 ml RBC on y axis. Expired blood group “AB” RBC (72 days old) were incubated with various solutions for 90 min at 37° C. Total protein was estimated using standard Bradford protein assay. There is a significant increase in protein retention in RBC stored in AMRUT but in those stored in HBSS and GALA.

FIG. 6 is a bar graph showing ATP restoration in expired RBC. Total ATP/0.5 ml RBC on y axis. Expired blood group “A” RBC (72 days old) were incubated with various solutions for 90 min at 37° C. Total ATP was estimated using standard bioluminescence assay. There is a significant increase in protein retention in RBC stored in AMRUT but in those stored in HBSS and GALA.

FIG. 7 is a bar graph showing ATP restoration in expired RBC. Total ATP/0.5 ml RBC on y axis. Expired blood group “AB” RBC (72 days old) were incubated with various solutions for 90 min at 37° C. Total ATP was estimated using standard bioluminescence assay. There is a significant increase in protein retention in RBC stored in AMRUT but in those stored in HBSS and GALA.

FIG. 8 is a bar graph showing DPG restoration in expired RBC. Expired blood group “B” RBC (72 days old) were incubated with various solutions for 90 min at 37° C. Total DPG was estimated using standard bioluminescence assay. There is a significant increase in DPG in RBC stored in AMRUT but not in those stored in HBSS and GALA.

FIG. 9 is a bar graph showing blood gas levels. Expired blood group “O” RBC (72 days old) were incubated with various solutions for 15 days at 4° C. Oxygen and Carbon dioxide concentrations were measured as a function of time of storage. Oxygen binding in RBC was greater in RBC stored in AMRUT than in other solutions through out the storage period. Correspondingly, Carbon dioxide binging was lowest in AMRUT RBC.

FIG. 10 is a bar graph showing Metabolic Parameters/Blood Chemistry. Expired blood group “O” RBC (72 days old) were incubated with various solutions for 15 days at 4° C. Glucose consumption and generation of lactic acid was measured as a function of time. Lactic acid generation was greatest in AMRUT RBC indicating robust metabolism.

FIG. 11 is a bar graph showing Metabolic Parameters/Blood Chemistry. Expired blood group “O” RBC (72 days old) were incubated with various solutions for 15 days at 4° C. Change in pH of the RBC suspensions was measured as a function of time. In spite of active metabolism and lactic acid production by AMRUT RBC, the pH remain high in these RBC suspension, indicating enhanced buffering capacity of AMRUT solution.

FIG. 12 is a graph showing blood gas levels. Expired blood group “B” RBC (72 days old) were incubated with various solutions for 15 days at 4° C. Oxygen and Carbon-dioxide concentrations were measured as a function of time of storage. Oxygen binding in RBC was greater in RBC stored in AMRUT than in other solutions through out the storage period. Correspondingly, Carbon dioxide binging was lowest in AMRUT RBC.

FIG. 13 is a bar graph showing Metabolic Parameters/Blood Chemistry. Expired blood group “B” RBC (72 days old) were incubated with various solutions for 15 days at 4° C. Glucose consumption, generation of lactic acid and pH was measured as a function of time. Lactic acid generation was greatest in AMRUT RBC indicating robust metabolism. In spite of active metabolism and lactic acid production by AMRUT RBC, the pH remain high in these RBC suspension, indicating enhanced buffering capacity of AMRUT solution.

FIG. 14 is a photograph of an electrophoretic gel. Note that liver NOS has a molecular mass of 140 kDa, whereas erythrocyte NOS (eNOS) has a molecular mass of 110 kDa. The solutions described herein (e.g., AMRUT, RASA) modulate the activity of eNOS.

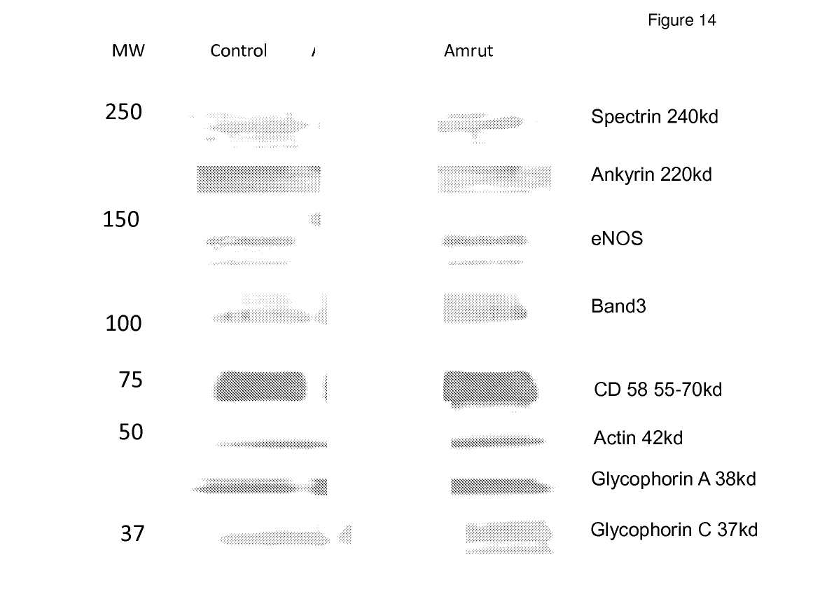

### DETAILED DESCRIPTION

A blood cell rejuvenation solution, termed “AMRUT”, was developed for restoration/rejuvenation of expired banked RBC. AMRUT restores RBC morphology, energy state and functionality of the RBC. By restoration/rejuvenation is meant that the level of NO in RBC treated with the described solutions is greater than 20% compared to untreated RBC. For example, the level of NO is greater than 50%, greater than 2-fold or more compared to untreated cells. NO is measured using standard methods. Based on the results described herein, RBC activities are restored after treatment with the solution and thus function normally upon transfusion into human patients. The solution thus saves expired RBC from being discarded and therefore alleviates blood supply shortages and reduce healthcare costs. The solution useful to restore functionality of expired banked RBC. AMRUT and RASA solutions are also useful to extend the shelf life of freshly drawn RBC. When freshly drawn RBC are stored in AMRUT, they may functionally survive for greater than 42 days (the current gold standard shelf life of banked blood). As a result of storage in AMRUT, the structural and functional stability and nitric oxide generation capability of RBC is extended beyond the currently accepted expiration date (42 days). Both these components play a major role in deformability of RBC and also vasodilatation.

The composition (solution) described herein is a mixture of adaptogenic metabolic modulators. It is customized for RBC and is different from other cell or tissue storage solutions, because of the differences between RBC metabolic pathways and the metabolic pathways of other cell types. For example, RBC lack mitochondria, nucleus and other intracellular organelles. As a result, the solution lacks ingredients (e.g., phosphocreatine, creatine monohydrate carnosine, dichloroacetate) which are relevant to mitochondrial and other organelle metabolic pathways.

### Banking of Blood

Blood transfusion, the most commonly performed procedure in US hospitals, has been associated with adverse outcomes in clinical applications. Although most outcome studies of transfusion are retrospective and thus subject to confounding variables, a growing body of evidence indicates that transfusion, especially with blood stored for a long duration (e.g., approximately 42 days), may not improve oxygen delivery, and may be associated with increased morbidity and mortality.

Numerous changes occur in RBCs during storage (collectively referred to as the “storage lesion”) that may alter their biological function, including delivery of oxygen to cells.

RBC “storage lesions” includes: morphological changes, slowed metabolism with a decrease in the concentration of adenosine triphosphate (ATP), acidosis with a decrease in the concentration of 2,3-DPG, a decrease in nitric oxide binding with hemoglobin, loss of function of cation pumps and consequent loss of intracellular potassium and accumulation of sodium within the cytoplasm, oxidative damage with changes to the structure of band 3 and lipid peroxidation, apoptotic changes with racemisation of membrane phospholipids and loss of parts of the membrane through vesiculation. AMRUT solution decreases the development of one or more storage lesions.

An important RBC phenotype that is susceptible to change during storage is the ability for the cell membrane to deform, which allows erythrocytes (6-8 μm in diameter) to traverse capillaries of similar, or even capillaries of smaller diameter (1 μm). Erythocyte deformability is a measurable property, e.g., using an ektacytometer. Ektacytometry based on laser diffraction analysis is a commonly preferred (and a fairly direct) method for measuring deformability (Baskurt et al., 2009, Biorheology 46 (3): 251-264). Deformability can also be measured indirectly, such as by how much pressure and/or time it takes cells pass through pores of a filter [i.e., filterability or filtration) using standard methods, e.g., those described in Advances in Hemodynamics and Hemorheology, Volume 1, edited by T. V]. How, or perfuse through capillaries (perfusion), having smaller diameters than the cells' (Shevkoplyas et al, 2006, Lab Chip 6(7):914-20).

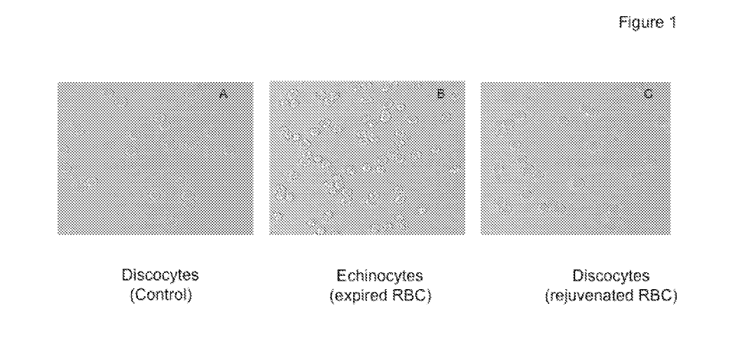

Typically, the cells are simply examined under standard microscope. For example, blood cells smeared on a slide (e.g., a standard glass (silica) slide, negatively charged) which has been coated with bovine serum albumin (BSA) to eliminate the negative charge. Conversely, fresh or aged RBC may also be fixed in 2% glutaraldehyde solution and observed under a microscope. Fresh RBC appear as discocytes (appearing as echinocytes on a negatively charged uncoated silica slide). Discocytes are donut-shaped as compared to echinocytes, which appear with spiny projections like an sea urchin. However, over time and as the cells age, the cells demonstrate discocyte to echinocytic transformation. The echinocyte morphology is a marker of an aging and less functional RBC (see FIGS. 1A-C). The echinocyte is less deformable as well. The change in deformability is a result of ATP depletion (a benchmark of blood cell aging) and also a result of ionic changes.

The various components of the storage lesion phenotype include depletion of nitric oxide or ability to generate nitric oxide due to attenuation of eNOS activity, 2,3-diphosphoglycerate (DPG), and adenosine triphosphate (ATP); increased free hemoglobin concentration from hemolysis; and/or increased RBC aggregability. Storage-related changes in cell membrane structure and function include membrane vesiculation, protein oxidation, lipid peroxidation, and loss of cell membrane deformability. Nitric oxide and ATP levels maintain and enhance cell membrane deformability. Nitric oxide and ATP, which are depleted during storage, are quickly replenished after transfusion of RBC in a living body. (Bennett-Guerrero et al., 2007, PNAS 104:17063-17068; Frank et al., 2013, Anesth Analg 116 (5): 975-81; Hogman et al., 2006, Transfusion 46:137-142). AMRUT solution was developed to reverse such storage lesions.

### RBC Functions

During their intravascular lifespan, RBC require energy to drive a number of vital cell functions. These include (1) maintenance of glycolysis; (2) maintenance of the electrolyte gradient between plasma and red cell cytoplasm through the activity of adenosine triphosphate (ATP)-driven membrane pumps; (3) synthesis of glutathione and other metabolites; (4) purine and pyrimidine metabolism; (5) maintenance of hemoglobin's iron in its functional, reduced, ferrous state; (6) protection of metabolic enzymes, hemoglobin, and membrane proteins from oxidative denaturation; and (7) preservation of membrane phospholipid asymmetry. RBCs depend on the anaerobic conversion of glucose by the Embden-Meyerhof pathway for the generation and storage of high-energy phosphates. Moreover, RBC possess a unique glycolytic bypass for the production of 2,3 bisphosphoglycerate (2,3-DPG), the Rapoport-Luebering shunt. This shunt bypasses the phosphoglycerate kinase (PGK) step and accounts for the synthesis and regulation of 2,3-DPG levels that decrease hemoglobin's affinity for oxygen. In addition, 2,3-DPG constitutes an energy buffer (Van Wijk et al., 2005, Blood 106: 4034-4042; Hogman et al., 2006, Transfusion 46:1543-1552). These functions are preserved, enhanced or ameliorated by AMRUT, an adaptogenic metabolic modulating RBC preservation/storage solution. For example, the metabolic pathways of the cell are altered to accommodate the needs of the cell.

### RBC Storage Limitations

Every year in the US, 14 million units of blood are collected, and 13.9 million units of RBCs are administered to 4.8 million patients. Approximately 1-15% of this blood is discarded because of time dependent expiration the world over, resulting in loss in valuable commodity and increased healthcare costs. RBCs may be stored for up to 42 days under controlled conditions before transfusion. AMRUT solution reverses the storage lesions and renders the expired blood viable for transfusion. It also extends the lifespan of freshly stored extracted blood longer than the current 42 day standard without any appreciable storage lesion.

The following materials and methods were used to generate the data described herein.

Blood. Expired RBC in transfusion bags, comprising of blood groups O, A, B and AB, was collected from a standard hospital blood bank. The blood was stored at 4° C. The blood was initially collected from the donors in standard Acid Citrate 2× Dextrose (AC2D) solution in 450 ml bags.

Rejuvenation Solution Design. Phosphate buffered saline (PBS), Hank's Balanced Salt Solution (HBSS) and GALA, were used as control in this rejuvenation study. GALA was modified by addition of adenosine, ribose, L-citrulline and increasing the concentration of L-arginine to formulate AMRUT solution. Composition of these solutions is given in Table 1. (See composition of RASA for preservation of freshly harvested RBC)

Kinetics of Discocyte-Echinocyte-Discocytes Transformation (Blood Types: O+, A+, AB+, and B+). RBC transform from discocytes to echinocytes upon aging due to loss in ATP, surface ionic changes and other degenerative factors. Echinocytes are less deformable and demonstrate diminished oxygen carrying capacity. The synthetic restoration/rejuvenation solution described herein restores ATP levels leading to transformation of echinocytes back into discocytes. This assay qualitates such transformation.

Expired RBC, 2 ml, were mixed with 10 ml of solution. Mixture was mixed well and incubated at 37° C. for 30 min increments up until 2 hours. At every 30 minute 10 μL of RBC was mixed with 500 uL of 2% Glutaraldehyde and mixed well.

50 μl of mixture was transferred on to a slide and a cover slip was sealed onto the slide with a coating such as clear nail polish, taking care to avoid any air bubbles.

The number of discocytes and echinocytes in five independent microscopic fields were counted at 400× and expressed as percentages of total cells in the fields. Transformation was observed under the microscope and a picture taken of each slide. At the end of two hours the remaining RBC solutions mixture was refrigerated and the discocyte-echinocytes were counted over the next 2 weeks. Data was expressed as % discocyte and echinocytes in 500 counted RBC per time point.

Alternatively, expired RBC, 2 ml, were mixed with 10 ml of solutions listed in Table 1. Mixture was mixed well and kept at 4° C. for 15 days. Samples were periodically assayed for morphology, pH, glucose, lactate, pCO₂ and pO₂ during the 2-week storage.

Metabolic Assays. Glucose, Lactate, pH, pO₂ and pCO₂ were measured using automatic online iSTAT monitoring system, that measures blood gas, electrolytes and chemistry in real time. System was purchased from Abaxis, Union City, Calif.

ATP Assay and 2,3 DPG Assay. Assay kit was purchased from Roche Diagnostics, Mannheim, Germany. ATP and DPG in the RBC was estimated according to the instructions provided with the kit.

### Rejuvenation of Expired Banked Red Blood Cells for Transfusion.

Irrespective of the blood group tested, expired RBC samples showed 80-90% echinocytes and about 10-20% discocytes at the start of the experiment. Upon incubation in the various storage solutions, echinocytes differentially transformed back into discocytes as shown in FIG. 1.

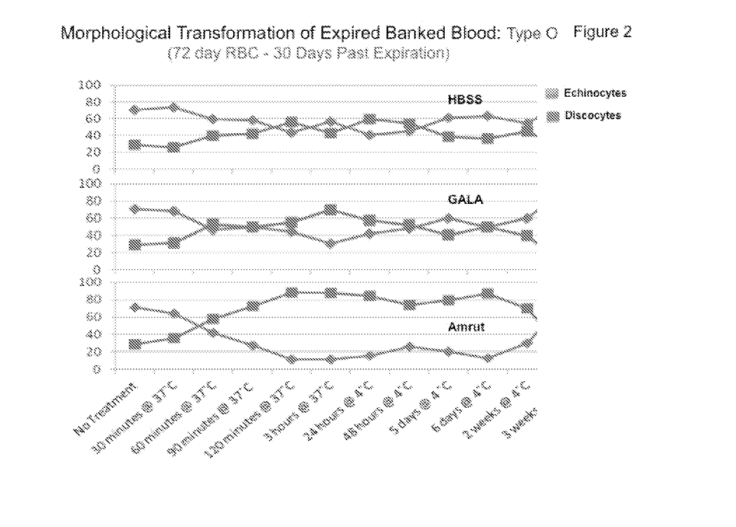

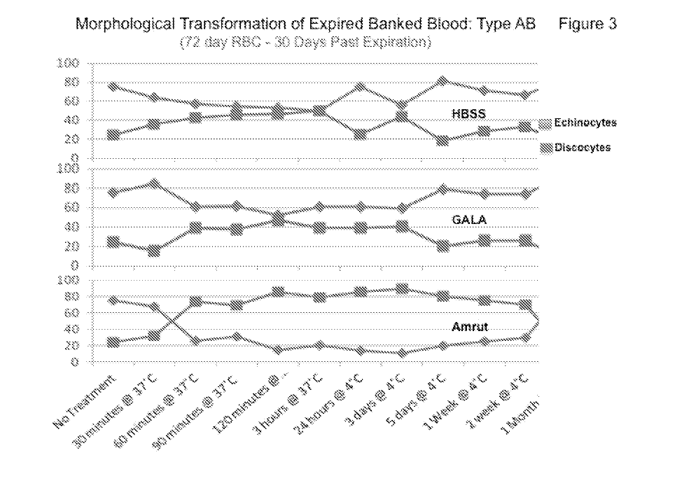

This transformation was solution dependent. RBC stored in HBSS and GALA remained echinocytes over the three week experimental period. In contrast, RBC stored in AMRUT transformed into discocytes (80%) within 30-120 min after the start of the experiment and remained discocytes throughout the experimental period (FIG. 2 and FIG. 3).

These results indicated that expired RBC morphology was restored to its original dicocyte state when treated with AMRUT but not with the other solutions tested.

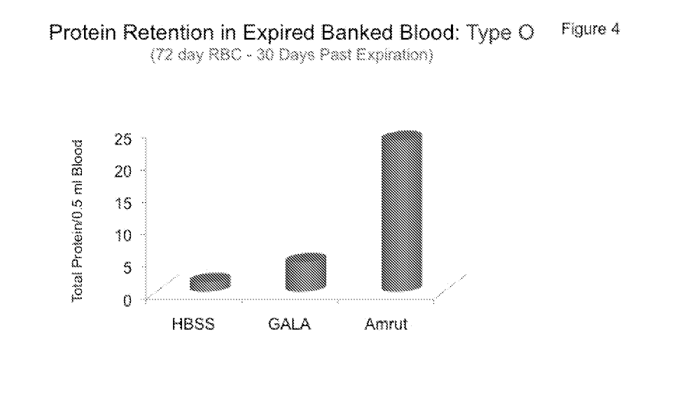

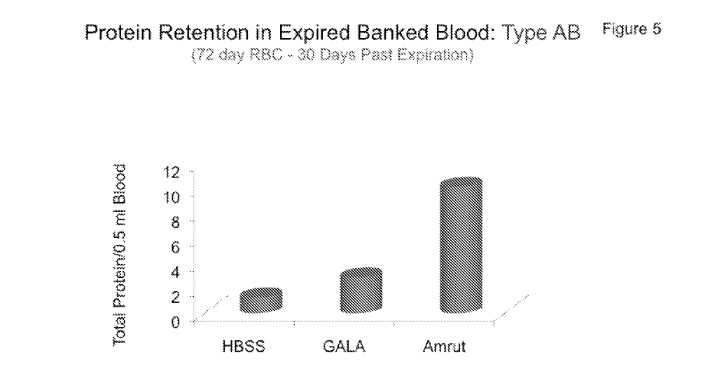

There are about 1 million molecules of hemoglobin (Hb) per RBC. This hemoglobin is lost during storage because of cell lysis (FIG. 4 and FIG. 5). RBC retain Hb to a maximal extent when treated with AMRUT as compared to all other solutions.

### High Energy Phosphate Restoration.

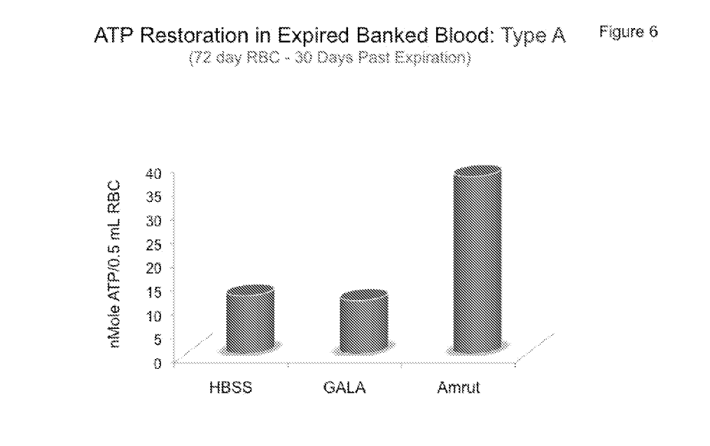

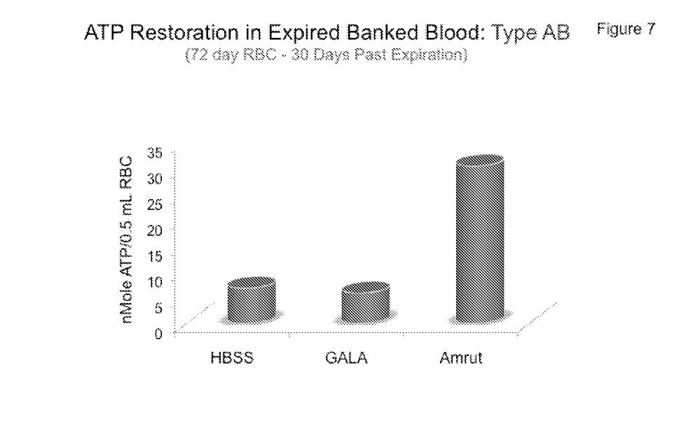

Majority of the storage lesions are induced because of time-dependent loss in RBC ATP during storage, for example, discocyte-echinocyte transformation. The reversal of morphology from echinocytes back to discocytes is ATP dependent. ATP levels in expired RBC upon incubation in AMRUT were rapidly restored within 90 min similar to fresh RBC levels by consumption of glucose via glycolysis. Restoration of ATP in AMRUT was greatest compared to all other solutions tested, FIGS. 6 and 7, and in both the blood groups under study. These results indicate that AMRUT is superior to other solutions tested in its ability to restore the expired RBC to their original morphological and physiological state.

### Restoration of 2,3 DPG Levels

DPG plays a crucial role in oxygen transport and positively affects the association-dissociation constant of oxygen binding to the hemoglobin molecule. A decrease in DPG levels reduces the oxygen carrying capacity of RBC that leads to profound ischemia. DPG decays very rapidly in stored RBC, with 60% decrease within 4 days of storage and almost 95% within 1 week of storage. Such RBC upon transfusion will perform poorly in the patient. In spite of this decay, blood banks routinely store RBC for 42 days.

The predominant pathways of carbohydrate metabolism in the RBC are glycolysis, the PPP and 2,3-diphosphoglycerate (2,3-DPG) metabolism (for hemoglobin and Oxygen). Glycolysis provides ATP for membrane ion pumps and NADH for reoxidation of methemoglobin. The PPP supplies the RBC with NADPH to maintain the reduced state of glutathione. The inability to maintain reduced glutathione in RBCs leads to increased accumulation of peroxides, predominantly H₂O₂, that in turn results in a weakening of the cell wall and concomitant hemolysis. Accumulation of H₂O₂ also leads to increased rates of oxidation of hemoglobin to methemoglobin that also weakens the cell wall. Glutathione removes peroxides via the action of glutathione peroxidase. The PPP in RBC is essentially the only pathway for these cells to produce NADPH. Any defect in the production of NADPH could, therefore, have profound effects on RBC survival, as in storage.

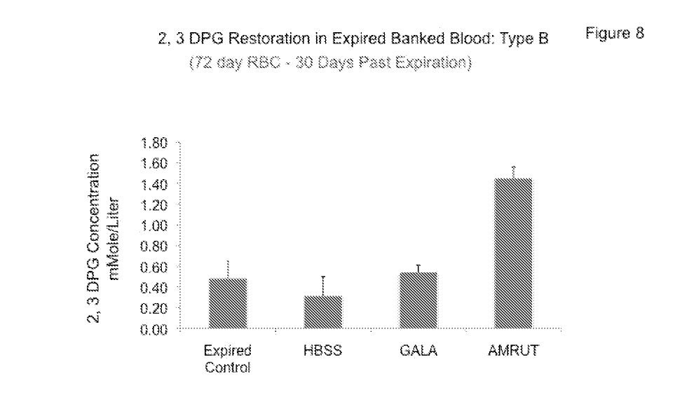

As shown in FIG. 8, amongst all the solutions tested, AMRUT rapidly restored 2,3 DPG levels to normal for any expired RBC. This increase in 2,3 DPG level was significantly greater in AMRUT than in GALA and HBSS.

Restoration of DPG (e.g., increasing DPG level) in RBC is mediated by pentose sugars: Ribose, Xylose, Arabinose, Ribulose, Xylulose. The role of pentose pathway (PPP) in RBC is to provide reduced equivalents such as NADPH to maintain redox state and avoid oxidative damage, especially during storage, by maintaining reduced glutathione via NADPH. Thus, the presence of a pentose sugar in the RBC rejuvenation solution is a key element to extending the shelf life and thus functionality of the cell.

### Metabolic Monitoring of Expired RBC Stored in Various Solutions

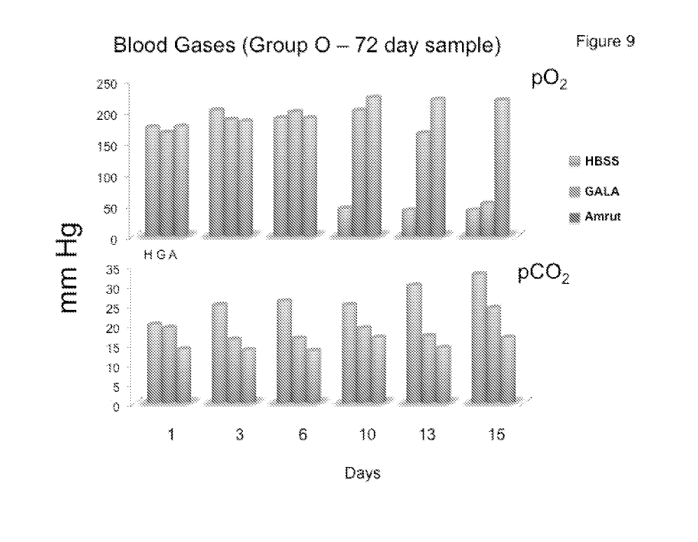

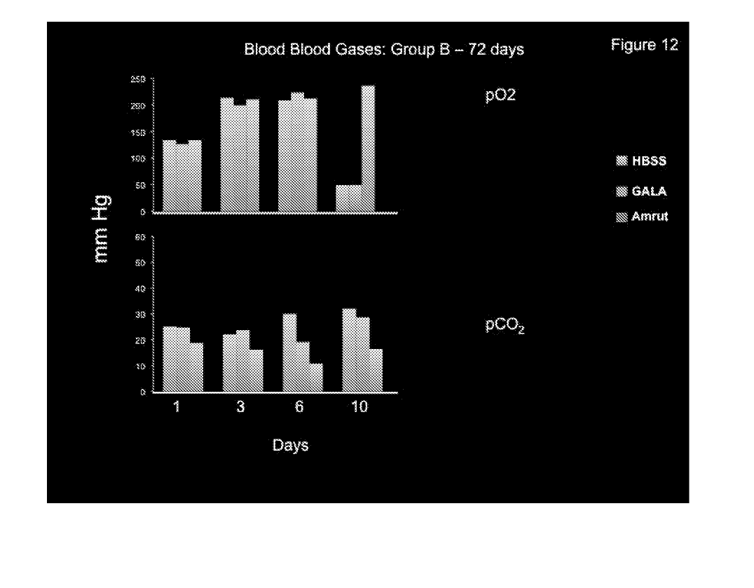

Expired RBC of various blood groups were resuspended in solutions under investigation and stored for 15 days a 4° C. The RBC suspensions were periodically tested for O₂, CO₂, lactate and glucose concentration, and change in pH during the time of storage. As shown in FIGS. 9-13, AMRUT and to certain extent GALA performed far better than other solutions tested. RBC of blood group O, remained restored to 15 days, in contrast, blood group B RBC, remained restored up to 10 days during storage. This difference is possibility of age of the expired RBC at the start of the experiment. Oxygen concentration is RBC stored in AMRUT and GALA was highest, correspondingly, CO₂ concentration was lowest in AMRUT amongst all other solutions. These data indicate that RBC in AMRUT remain oxygenated and bright red (as in arterial blood), in contrast, RBC are less oxygenated and remain darker (as in venous blood), when stored in all other solutions, FIGS. 9 and 12.

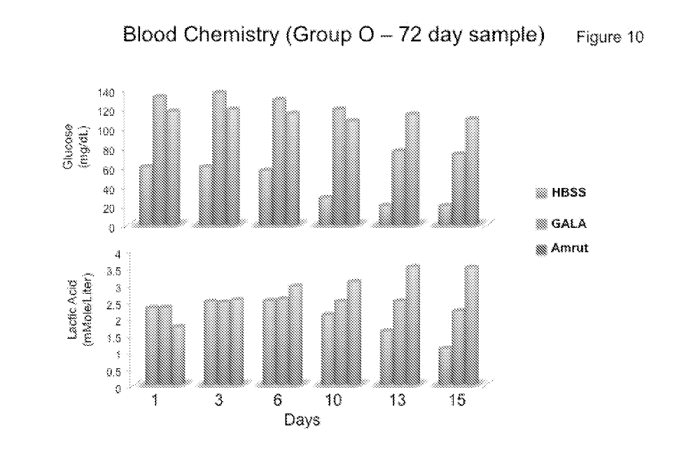

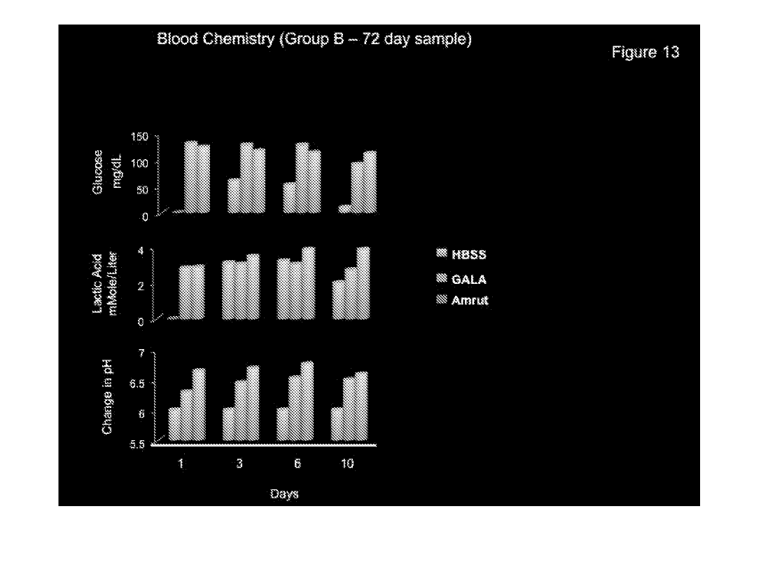

Similarly, glucose levels and corresponding lactate levels remain very high in AMRUT than other solutions, indicating utilization of alternative pathways of metabolism of glucose, including glycolysis, HMP shunt (FIGS. 10 and 13). This is confirmed from the fact that, ATP and 2,3 DPG levels are fully restored in RBC stored in AMRUT but not in other solutions. As Glucose remains available even after 15 day storage, RBC stored in AMRUT may remain metabolically viable and functionally active for extended period of time.

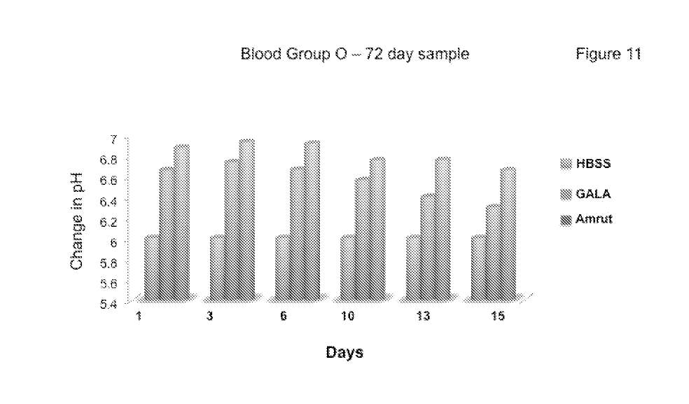

One of the major problems of long-term storage is decrease in pH due to formation of lactic acid, which is detrimental to the RBC in the long run. Even though metabolic pathways remain robustly active in RBC stored in AMRUT and lactic acid formation is greatest (FIGS. 10 and 13) there is only a marginal decrease in pH. At the end of 15 days, pH of AMRUT was about 6.6-6.8 (FIGS. 11 and 13). However, true pH must take into consideration the temperature of the solution. For the online monitoring system, iSTAT was used for measuring pH has a built in algorithm that automatically corrects the pH for 37° C. There is an inverse relationship between temperature and pH. Higher the temperature lower is the pH. Therefore, pH of 6.8 at 37° C. will correspond to pH of 7.5 at 4° C., the storage temperature of RBC in the blood banks. Therefore, AMRUT also provides a strong buffering capacity. Despite the ability of AMRUT solution to promote active metabolism of RBC, which leads to an increase in lactic acid, the solution effectively buffers the effect of the lactic acid concentration.

### RBC for Transfusion

RBC are collected from living subjects into bags, tubes, bottles, or other containers containing an anti-coagulant, e.g., citrate, heparin, EDTA and their derivatives. RBC are prepared from whole blood by removing plasma (liquid portion of the blood). Typically, RBC are spun out by centrifugation. Leukocytes (white blood cells) are generally removed by filtration shortly after donation to yield a population of “leukocyte-reduced red blood cells”. This step is done before storage because high numbers of leukocytes remaining in a unit of RBCs during the storage process can fragment, deteriorate, release cytokines and may cause adverse reactions in some transfusion recipients. Washed, packed RBC are then suspended in a storage solution at various ratios (e.g., 4:1; 7:1).

AMRUT solution rejuvenates expired RBC, reduces the non functionality of aged or aging RBC, and prolongs the effective shelf life of RBC to greater than 42 days after collection when used as a storage solution immediately or shortly after collection of the RBC.

AMRUT solution is tailored for storage of leukocyte-reduced RBC or purified RBC (>55% hematocrit) compared to whole blood (which includes all cell types—red blood cells, leukocytes, granulocytes, monocytes, and platelets), because the calcium in the solution activates platelets, thereby leading to clotting. However, the recipe for AMRUT solution (see Table 1) without calcium and magnesium (e.g., lacking calcium chloride, magnesium chloride and magnesium sulfate) with added citrate is suitable for storage/preservation of whole blood.

### Improved Blood Storage Solution

Whole blood and/or Red blood cells (RBC) are the most widely transfused blood component throughout the world. At present, the protocol for the storage of whole blood or packed RBC (for up to 42 days) is the collection of blood into anticoagulant solutions (ACD (acid, citrate, dextrose, a.k.a., anti-coagulant, citrate, dextrose) or CPDA-1 (citrate phosphate dextrose adenine). The whole blood can be fractionated into packed RBC, platelets, plasma or platelet rich plasma. All blood components are generally stored at 4° C.±2° C.

An increased rate of morbidity and mortality is associated with the transfusion of “older” RBC, e.g., those cells approaching the standard 42 day shelf life of stored RBC. Progressive loss in ATP, 2,3 DPG and nitric oxide and decreased deformability of RBC membranes impairs RBC function of oxygen delivery and vasodilatation. Expired blood must be discarded. Thus, there is a continuing need for RBC storage that results in longer storage duration, better recovery percentage, and improved physiological functioning of the transfused RBC.

In answer to the question of how one would improve the standard CPDA solution, a blood storage solution, termed “RASA”, was developed for extending the storage duration of fresh whole blood or packed fresh red blood cells. The term fresh in this context means that the a few seconds to a few minutes, 1, 2, 5, 10 minutes but no longer than 1 hour has elapsed since the blood was removed (drawn) from the circulation of a living body. Generally to avoid coagulation, fresh blood refers to blood that spends only a few seconds between the circulation of a living body and a storage/anti-coagulant solution.

When freshly drawn RBC are stored in RASA, they may functionally survive for greater than 42 days (the current gold standard shelf life of banked blood). As a result of storage in RASA, the structural and functional stability and nitric oxide generation capability of RBC is extended beyond the currently accepted expiration date (42 days). Both these components play a major role in deformability of RBC and also vasodilatation.

The composition (solution) described herein is a mixture of adaptogenic metabolic modulators. It is customized for RBC and is different from other cell or tissue storage solutions, because of the differences between RBC metabolic pathways and the metabolic pathways of other cell types. For example, RBC lack mitochondria, nucleus and other intracellular organelles. As a result, the solution lacks ingredients (e.g., phosphocreatine, creatine monohydrate carnosine, dichloroacetate), which are relevant to mitochondrial and other organelle metabolic pathways.

A key element of the solution is a compound that increases 2,3 DPG. In preferred embodiments, the compound comprises a pentose sugar. Examples of suitable pentose sugars include, but are not limited to Ribose, Xylose, Arabinose, Ribulose, or Xylulose. Preferably the pentose sugar is Ribose. Compounds such as pentose sugars that increase and/or preserve 2,3, DPG levels in the RBC and increase their oxygen-carrying capacity.

The solution also contains adenosine and/or adenine, a component of adenosine triphosphate (ATP).

The solution further contains a compound that serves as a substrate for the enzyme, nitric oxide synthase (NOS). Examples include, but are not limited to L-arginine and L-citrulline and/or a salt or derivative thereof. Nitric oxide (NO) is synthesized from L-arginine by the enzyme NOS. The reaction involves the transfer of electrons from NADPH, via the flavins FAD and FMN in the carboxy-terminal reductase domain, to the heme in the amino-terminal oxygenase domain, where the substrate L-arginine is oxidised to L-citrulline and NO.

Other ingredients may also be present in the composition, e.g., ascorbic acid, which increases transport of L-arginine and/or L-citrulline into RBC. NOS is important for vasodilatation as well as prevention of clot formation (by inhibiting platelet activation) and preventing intimal hyperplasia.

The physiological salt solution portion of the composition/solution comprises any one or combination of the following: Calcium chloride, Potassium chloride, Potassium phosphate, Magnesium chloride, Magnesium sulfate (heptahydrate), Sodium chloride, Sodium bicarbonate, and Sodium phosphate. Other ingredients include D-Glucose, Glutathione [e.g., Glutathione (reduced)], and/or Ascorbic acid a source of energy, reducing potential and antioxidant activity.

### Solution for Increasing Storage Duration of RBC

The following solutions are useful to increase the storage duration, or extend the functional lifespan, of RBC. The red blood cells may be in freshly drawn whole blood or may be packed red blood cells. The table below shows the concentration ranges of each ingredient in suitable storage solutions for preserving and storing RBC in comparison to the currently used CPDA-1 solution. The concentration of components of CPDA are shown in bold type.

TABLE 1

| Components | CPDA-1 | | RASA | |
|---|---|---|---|---|
| Potassium phosphate (e.g., monobasic) | | | 0-1 | gm/L |
| Magnesium sulfate (e.g., heptahydrate) | | | 0-0.2 | gm/L |
| Sodium bicarbonate | | | 0-5 | gm/L |
| Sodium Phosphate (e.g., Monobasic) | 2.20 | gm/L | 2.20 | gm/L |
| D-Glucose (a.k.a, Dextrose) | 31.70 | gm/L | 10-32 | gm/L |
| Glutathione (e.g., reduced) | | | 0.09-0.2 | gm/L |
| Ascorbic acid | | | 0.31-0.65 | gm/L |
| L-Arginine | | | 0.21-0.84 | gm/L |
| Citric Acid | 3.30 | gm/L | 3.30 | gm/L |
| Sodium Citrate | 26.30 | gm/L | 26.30 | gm/L |
| Adenine | 0.028 | gm/L | 0.028 | gm/L |
| Adenosine | | | 1-5 | gm/L |
| Ribose (21 mM) | | | 1.5-7.5 | gm/L |
| L-Citrulline (5 mM) | | | 0.44-1.76 | gm/L |
| Mannitol (21 mM) | | | 0-8 | gm/L |

| | |
|---|---|
| Distilled water | To 1.00 L |

After the solution is made as described above, the solution is adjusted pH 7.4, at 4° C. and 37° C.; or at desired temperature, with NaOH, NaHCO₃, or THAM

The following solution (RASA) is useful for extending the functional lifespan of freshly drawn whole blood or packed RBC. The concentration of components of CPDA have not been altered in the RASA solutions (in bold).

| Components | CPDA-1 | | RASA | |
|---|---|---|---|---|
| Potassium phosphate (e.g., monobasic) | | | 0.5 | gm/L |
| Magnesium sulfate (e.g., heptahydrate) | | | 0.1 | gm/L |
| Sodium bicarbonate | | | 3.11 | gm/L |
| Sodium Phosphate (e.g., Monobasic) | 2.20 | gm/L | 2.20 | gm/L |
| D-Glucose (a.k.a., Dextrose) | 31.70 | gm/L | 18.00 | gm/L |
| Glutathione (e.g., reduced) | | | 0.09 | gm/L |
| Ascorbic acid | | | 0.31 | gm/L |
| L-Arginine | | | 0.422 | gm/L |
| Citric Acid | 3.30 | gm/L | 3.30 | gm/L |
| Sodium Citrate | 26.30 | gm/L | 26.30 | gm/L |
| Adenine | 0.028 | gm/L | 0.028 | gm/L |
| Adenosine | | | 1.370 | gm/L |
| Ribose (21 mM) | | | 3.15 | gm/L |
| L-Citrulline (5 mM) | | | 0.88 | gm/L |
| Mannitol (21 mM) | | | 3.83 | gm/L |

| | |
|---|---|
| Distilled water | 1.00 L |

After the solution is made as described above, it is adjusted pH 7.4, at 4° C. and 37° C.; or at desired temperature, with NaOH, NaHCO₃, or THAM.

### Banking of Blood

RBC are collected from living subjects into bags, tubes, bottles, or other containers containing an anti-coagulant, e.g., citrate, heparin, EDTA and their derivatives. RBC are prepared from whole blood by removing plasma (liquid portion of the blood). Typically, RBC are spun out by centrifugation. Leukocytes (white blood cells) are generally removed by filtration shortly after donation to yield a population of “leukocyte-reduced red blood cells”. This step is done before storage because high numbers of leukocytes remaining in a unit of RBCs during the storage process can fragment, deteriorate, release cytokines and may cause adverse reactions in some transfusion recipients. Washed, packed RBC are then suspended in a storage solution at various ratios (e.g., 4:1; 7:1). Storage of RBC is critical for extending the lifespan of the RBC for future use in transfusions for patients in need.

Blood transfusion, the most commonly performed procedure in US hospitals, has sometimes been associated with adverse outcomes in clinical applications. Although most outcome studies of transfusion are retrospective and thus subject to confounding variables, a growing body of evidence indicates that transfusion, especially with blood stored for a long duration (e.g., approximately 42 days), may not improve oxygen delivery, and may be associated with increased morbidity and mortality.

Numerous changes occur in RBCs during storage (collectively referred to as the “storage lesion”) that may alter their biological function, including delivery of oxygen to cells.

RBC “storage lesions” includes: morphological changes, slowed metabolism with a decrease in the concentration of adenosine triphosphate (ATP), acidosis with a decrease in the concentration of 2,3-DPG, a decrease in nitric oxide binding with hemoglobin, loss of function of cation pumps and consequent loss of intracellular potassium and accumulation of sodium within the cytoplasm, oxidative damage with changes to the structure of band 3 and lipid peroxidation, apoptotic changes with racemisation of membrane phospholipids and loss of parts of the membrane through vesiculation. Storage of RBC in RASA solution decreases the development of storage lesions.

An important RBC phenotype that is susceptible to change during storage is the ability for the cell membrane to deform, which allows erythrocytes (6-8 μm in diameter) to traverse capillaries of similar, or even smaller diameter (1 μm). Erythocyte deformability is a measurable property, e.g., using an ektacytometer. Ektacytometry based on laser diffraction analysis is a commonly preferred (and a fairly direct) method for measuring deformability (Baskurt et al., 2009, Biorheology 46 (3): 251-264). Deformability can also be measured indirectly, such as by how much pressure and/or time it takes cells pass through pores of a filter (i.e., filterability or filtration) using standard methods, e.g., those described in Advances in Hemodynamics and Hemorheology, Volume 1, edited by T. V. How, or perfuse through capillaries (perfusion), having smaller diameters than the cells' (Shevkoplyas et al, 2006, Lab Chip 6(7):914-20).

Typically, the cells are simply examined under standard microscope. For example, blood cells smeared on a slide (e.g., a standard glass (silica) slide, negatively charged) which has been coated with bovine serum albumin (BSA) to eliminate the negative charge. Conversely, fresh or aged RBC may also be fixed in 2% glutaraldehyde solution and observed under a microscope. Fresh RBC appear as discocytes (appearing as echinocytes on a negatively charged uncoated silica slide). However, over time and as the cells age, the cells demonstrate discocyte to echinocytic transformation. The echinocyte morphology is a marker of an aging and less functional RBC. The echinocyte is less deformable as well. The change in deformability is a result of ATP depletion (a benchmark of blood cell aging) and also a result of ionic changes.

The various components of the storage lesion include depletion of nitric oxide or ability to generate nitric oxide due to attenuation of eNOS activity, 2,3-diphosphoglycerate (DPG), and adenosine triphosphate (ATP); increased free hemoglobin concentration from hemolysis; and increased RBC aggregability. Storage-related changes in cell membrane structure and function include membrane vesiculation, protein oxidation, lipid peroxidation, and loss of cell membrane deformability. Because nitric oxide and ATP levels are thought to maintain and enhance cell membrane deformability, and given that nitric oxide and ATP are quickly replenished after transfusion of RBC, the loss of deformability and some of the storage lesions may be reversible (Bennett-Guerrero et al., 2007, PNAS 104:17063-17068; Frank et al., 2013, Anesth Analg 116 (5): 975-81; Hogman et al., 2006, Transfusion 46:137-142). RASA solution was developed to prevent such storage lesions.

### RBC Functions

During their intravascular lifespan, RBC require energy to drive a number of vital cell functions. These include (1) maintenance of glycolysis; (2) maintenance of the electrolyte gradient between plasma and red cell cytoplasm through the activity of adenosine triphosphate (ATP)-driven membrane pumps; (3) synthesis of glutathione and other metabolites; (4) purine and pyrimidine metabolism; (5) maintenance of hemoglobin's iron in its functional, reduced, ferrous state; (6) protection of metabolic enzymes, hemoglobin, and membrane proteins from oxidative denaturation; and (7) preservation of membrane phospholipid asymmetry. RBCs depend on the anaerobic conversion of glucose by the Embden-Meyerhof pathway for the generation and storage of high-energy phosphates. Moreover, RBC possess a unique glycolytic bypass for the production of 2,3 bisphosphoglycerate (2,3-DPG), the Rapoport-Luebering shunt. This shunt bypasses the phosphoglycerate kinase (PGK) step and accounts for the synthesis and regulation of 2,3-DPG levels that decrease hemoglobin's affinity for oxygen. In addition, 2,3-DPG constitutes an energy buffer (Van Wijk et al., 2005, Blood 106: 4034-4042; Hogman et al., 2006, Transfusion 46:1543-1552). These functions are preserved by the solutions and methods described herein.

### RBC Storage Limitations

Every year in the US, 14 million units of blood are collected, and 13.9 million units of RBCs are administered to 4.8 million patients. Approximately 1-15% of this blood is discarded because of time dependent expiration the world over, resulting in loss in valuable commodity and increased healthcare costs. RBCs may be stored for up to 42 days under controlled conditions before transfusion. RASA solution was developed to extend the lifespan of freshly stored extracted blood or packed RBC longer than the current 42 day standard without any appreciable storage lesion.

In one embodiment, the solutions described herein extend the lifespan of RBC for more than 42 days, for example, 45 days, 50 days, 55 days, 60 days, 65 days, 70 days, 75 days, 80 days, 85 days, 90 days, 95 days, or 100 days, without any appreciable storage lesion.

Preferably the collected blood is stored between 4 and 11° C.

### Characterization of Storage Solutions

Characterization of the compositions and methods described herein can be performed by the ordinarily skilled artisan utilizing methods known in the art. The assays described herein are illustrative and non-limiting. Any of the assays described herein may be performed in comparison with currently used standard storage solutions, such as CPD or CPDA-1, to demonstrate the superior properties of the compositions of the present invention.

### Kinetics of Discocyte-Echinocyte Transformation.

RBC transform from discocytes to echinocytes upon aging due to loss in ATP, surface ionic changes and other degenerative factors. Echinocytes are less deformable and demonstrate diminished oxygen carrying capacity. If by using the solutions described herein the ATP levels are maintained, then the stored RBCs will take longer or will not transform from discocytes to echinocytes. This assay qualitates such transformation and assesses the ability of the storage solution to prevent aging of RBC due to loss in ATP.

RBC stored in the compositions described herein, such as RASA, can be examined, for example, by microscope, to qualitatively assess the morphological change from discocyte to echinocyte. Transformation can be examined over weeks to assess the optimal storage duration, or time point at which a certain proportion of the stored RBC transform from discocyte to echinocytes.

### High Energy Phosphate Levels of RBC Stored in Various Solutions.

Majority of the storage lesions are induced because of time-dependent loss in RBC ATP during storage, for example, discocyte-echinocyte transformation. ATP levels decrease rapidly in stored RBC, and RBC with low ATP levels are perform poorly when transfused to a patient. Quantification of ATP levels from RBC stored in the solutions of the present invention demonstrate extended lifespan of the RBC.

ATP levels can be quantified using an assay kit purchased from Roche Diagnostics, Mannheim, Germany. ATP in the RBC can be estimated according to the instructions provided with the kit. Maintenance of ATP levels over time indicates increased storage potential of the storage solution. Higher levels of ATP and 2,3 DPG in RBCs stored in the solutions of the present invention, such as RASA, compared to standard storage solutions, such as CPDA-1, demonstrate the extended lifespan of RBCs by storage in RASA and the superiority of the solution compared to the standard solutions.

### 2,3 DPG Levels of RBC Stored in Various Solutions.

DPG plays a crucial role in oxygen transport and positively affects the association-dissociation constant of oxygen binding to the hemoglobin molecule. A decrease in DPG levels reduces the oxygen carrying capacity of RBC that leads to profound ischemia. DPG decays very rapidly in stored RBC, with 60% decrease within 4 days of storage and almost 95% within 1 week of storage. Such RBC upon transfusion will perform poorly in the patient. In spite of this decay, blood banks routinely store RBC for 42 days.

The predominant pathways of carbohydrate metabolism in the RBC are glycolysis, the PPP and 2,3-diphosphoglycerate (2,3-DPG) metabolism (for hemoglobin and Oxygen). Glycolysis provides ATP for membrane ion pumps and NADH for reoxidation of methemoglobin. The PPP supplies the RBC with NADPH to maintain the reduced state of glutathione. The inability to maintain reduced glutathione in RBCs leads to increased accumulation of peroxides, predominantly H₂O₂, that in turn results in a weakening of the cell wall and concomitant hemolysis. Accumulation of H₂O₂ also leads to increased rates of oxidation of hemoglobin to methemoglobin that also weakens the cell wall. Glutathione removes peroxides via the action of glutathione peroxidase. The PPP in RBC is essentially the only pathway for these cells to produce NADPH. Any defect in the production of NADPH could, therefore, have profound effects on RBC survival, as in storage.

2,3 DPG levels are quantified using an assay kit purchased from Roche Diagnostics, Mannheim, Germany. 2,3 DPG in the RBC can be estimated according to the instructions provided with the kit. Maintenance of 2,3 DPG levels over time indicates increased storage potential of the storage solution. Higher levels of 2,3 DPG in RBCs stored in the solutions of the present invention, such as RASA, compared to standard storage solutions, such as CPDA-1, demonstrate the extended lifespan of RBCs by storage in RASA and the superiority of the solution compared to the standard solutions.

### Metabolic Monitoring RBC Stored in Various Solutions.

RBC of various blood groups were resuspended in solutions under investigation and stored for 15 days a 4° C. The RBC suspensions were periodically tested for O₂, CO₂, lactate and glucose concentration, and change in pH during the time of storage. Glucose, Lactate, pH, pO₂ and pCO₂ can be measured using automatic online iSTAT monitoring system, that measures blood gas, electrolytes and chemistry in real time. System was purchased from Abaxis, Union City, Calif.

High oxygen concentrations in RBCs stored in the solutions of the present invention indicate that the RBCs remain oxygenated. Correspondingly, low CO₂ concentration in RBCs stored in solutions of the present invention indicate that the RBCs are more oxygenated.

High glucose levels and corresponding lactate levels in RBCs stored in the solutions of the present invention indicate utilization of alternative pathways of metabolism of glucose, including glycolysis, HMP shunt. As glucose remains available after extended storage duration, the RBC may remain metabolically viable and functionally active for an extended period of time.

One of the major problems of long-term storage is decrease in pH due to formation of lactic acid, which can be detrimental to the RBC in the long run. As metabolic pathways remain robustly active in RBC stored in solutions, lactic acid formation may be increased and could result in decreases in pH. Decreases in pH are undesirable for RBCs that are intended for transfusion into patients. Solutions of the present invention may demonstrate strong buffering capacity, such that although lactic acid formation may be increased due to active metabolic pathways, the true pH of the stored blood remains at the optimal pH range for storage and function of the RBCs.

For the online monitoring system, iSTAT was used for measuring pH has a built in algorithm that automatically corrects the pH for 37° C. There is an inverse relationship between temperature and pH. Higher the temperature lower is the pH. Therefore, pH of 6.8 at 37° C. will correspond to pH of 7.5 at 4° C., the storage temperature of RBC in the blood banks.

### OTHER EMBODIMENTS

While the invention has been described in conjunction with the detailed description thereof, the foregoing description is intended to illustrate and not limit the scope of the invention, which is defined by the scope of the appended claims. Other aspects, advantages, and modifications are within the scope of the following claims.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All published references, documents, manuscripts and scientific literature cited herein are hereby incorporated by reference.

While this invention has been particularly shown and described with references to preferred embodiments thereof, it will be understood by those skilled in the art that various changes in form and details may be made therein without departing from the scope of the invention encompassed by the appended claims.

1. A method for extending the shelf life of a red blood cell or storing a red blood cell ex vivo, comprising contacting said cell with a composition comprising a synthetic physiological salt solution and a compound that increases or preserves nitric oxide.

2. The method of claim 1, wherein said compound is a substrate of nitric oxide synthase.

3. The method of claim 2, wherein said compound comprises
L-citrulline or a salt thereof,
L-arginine or a salt thereof, or
both L-citrulline and L-arginine, or salts thereof.

4. The method of claim 1, further comprising a compound that increases 2,3-diphosphoglycerate (DPG) in said cell or preserves cell deformability.

5. The method of claim 4, wherein said compound that increases 2,3 DPG comprises a pentose sugar.

6. The method of claim 2, wherein said pentose sugar is selected from the group consisting of Ribose, Xylose, Arabinose, Ribulose, or Xylulose.

7. The method of claim 1, wherein the physiological salt solution comprises Calcium chloride, Potassium chloride, Potassium phosphate, Magnesium chloride, Magnesium sulfate, Sodium chloride, Sodium bicarbonate, Sodium phosphate.

8. The method of claim 1, wherein said composition further comprises D-Glucose, Glutathione, Ascorbic acid.

9. The method of claim 1, wherein the red blood cell is freshly drawn from a living animal or has been stored ex vivo.

10. The method of claim 1, wherein said synthetic physiological salt solution composition comprises
Compounds
L-citrulline or a salt thereof,
L-Arginine or a salt thereof,
Potassium phosphate,
Magnesium chloride,
Magnesium sulfate,
Sodium chloride,
Sodium bicarbonate,
Sodium phosphate.
D-Glucose,
Glutathione,
Ascorbic acid,
Potassium chloride,
Adenine,
Adenosine,
Calcium chloride, and
Ribose.

11. The method of claim 1, wherein the composition comprises

| COMPOUND | gm/L | |
|---|---|---|
| Calcium chloride | (0.01 mM) | 0.0015; |
| Potassium phosphate (monobasic) | (0.44 mM) | 0.06; |
| Magnesium chloride (Hexahydrate) | (0.5 mM) | 0.102; |
| Magnesium sulfate (Heptahydrate) | (0.5 mM) | 0.123; |
| Sodium chloride | (100.0 mM) | 5.844; |
| Sodium bicarbonate | (35.0 mM) | 2.941; |
| Sodium phosphate (dibasic; heptahydrate) | (10.0 mM) | 2.679; |
| D-dextrose/glucose | (108.0 mM) | 19.457; |
| Glutathione (reduced) | (0.50 mM) | 0.153; |
| Ascorbic Acid | (1.70 mm) | 0.31; |
| L-Arginine | (3.00 mm) | 0.525; |
| Adenine | (1.50 mM) | 0.204; |
| Adenosine | (7.00 mM) | 1.869; |
| L-citrulline | (8.00 mM) | 1.401; and |
| Ribose | (21.0 mM) | 3.152. |

12. The method of claim 1, wherein said composition comprises

| COMPOUND | Ranges | |
|---|---|---|
| Calcium chloride | 0-1.3 | mM; |
| Potassium chloride | 0-4.5 | mM; |
| Potassium phosphate (monobasic) | 0.1-1.00 | mM; |
| Magnesium chloride (Hexahydrate) | 0-1 | mM; |
| Magnesium sulfate (Heptahydrate) | 0-1 | mM; |
| Sodium chloride | 0-140 | mM; |
| Sodium bicarbonate | 5-50 | mM; |
| Sodium phosphate (dibasic; heptahydrate) | 1-25 | mM; |
| D-dextrose/glucose | 50-200 | mM; |
| Glutathione (reduced) | 0-5 | mM; |
| Ascorbic Acid | 0-5 | mM; |
| L-Arginine | 0-5 | mM; |
| Adenine | 1-5 | mM; |
| Adenosine | 1-10 | mM; |
| L-citrulline | 0-10 | mM; |
| Ribose | 5-25 | mM; and |
| Mannitol | 0-50 | mM. |

13. The method of claim 1, wherein said red blood cell is contacted with said composition at or after day 42 of storage.

14. The method of claim 1, wherein said red blood cell is contacted with said composition at or after day 21 of storage.

15. The method of claim 1, wherein said red blood cell is contacted with said composition at or after day 8 of storage.

16. The method of claim 1, wherein said red blood cell is contacted with said composition at or after day 1 of storage.

17. The method of claim 1, wherein said red blood cell is contacted with said composition within 1 minute to 24 hours after removal from a living subject.

18. A blood rejuvenation or storage composition comprising

| COMPOUND | Ranges | |
|---|---|---|
| Calcium chloride | 0-1.3 | mM; |
| Potassium chloride | 0-4.5 | mM; |
| Potassium phosphate (monobasic) | 0.1-1.00 | mM; |
| Magnesium chloride (Hexahydrate) | 0-1 | mM; |
| Magnesium sulfate (Heptahydrate) | 0-1 | mM; |
| Sodium chloride | 0-140 | mM; |
| Sodium bicarbonate | 5-50 | mM; |
| Sodium phosphate (dibasic; heptahydrate) | 1-25 | mM; |
| D-dextrose/glucose | 50-200 | mM; |
| Glutathione (reduced) | 0-5 | mM; |
| Ascorbic Acid | 0-5 | mM; |
| L-Arginine | 0-5 | mM; |
| Adenine | 1-5 | mM; |
| Adenosine | 1-10 | mM; |
| L-citrulline | 0-10 | mM; |
| Ribose | 5-25 | mM; and |
| Mannitol | 0-50 | mM. |

19. A composition for storage of fresh red blood cells comprising:
Compounds
Sodium phosphate;
D-Glucose;
Glutathione;
Ascorbic acid;
L-Arginine or a salt thereof;
Citric Acid;
Sodium citrate;
Adenine;
Adenosine;
Ribose; and
L-Citrulline or a salt thereof.

20. A composition for storage of fresh red blood cells comprising:
Compounds
Potassium phosphate;
Magnesium sulfate;
Sodium bicarbonate;
Sodium phosphate;
D-Glucose;
Glutathione;
Ascorbic acid;
L-Arginine or a salt thereof;
Citric Acid;
Sodium citrate;
Adenine;
Adenosine;
Ribose;
L-Citrulline or a salt thereof; and
Mannitol.

21. A composition for storage of fresh red blood cells comprising:
Compounds
Sodium bicarbonate;
Sodium phosphate;
D-Glucose;
Glutathione;
Ascorbic acid;
L-Arginine or a salt thereof;
Citric Acid;
Sodium citrate;
Adenine;
Adenosine;
Ribose;
L-Citrulline or a salt thereof; and
Mannitol.

22. A composition for storage of fresh red blood cells comprising:
0-5 gm/L Sodium bicarbonate;
2.20 gm/L Sodium Phosphate;
10-32 gm/L D-Glucose;
0.09-0.2 gm/L Glutathione;
0.31-0.65 gm/L Ascorbic Acid;
0.21-0.84 gm/L L-Arginine;
3.30 gm/L Citric Acid;
26.30 gm/L Sodium Citrate;
0.028 gm/L Adenine;
1-5 gm/L Adenosine;
1.5-7.5 gm/L Ribose;
0.44-1.76 gm/L L-Citrulline; and
0-8 gm/L Mannitol.

23. The composition of claim 22, further comprising 0-1 gm/L Potassium phosphate or 0-0.2 gm/L Magnesium sulfate.

24. A composition for storage of fresh red blood cells comprising:
3.11 gm/L Sodium bicarbonate;
2.20 gm/L Sodium Phosphate;
18 gm/L D-Glucose;
0.09 gm/L Glutathione;
0.31 gm/L Ascorbic Acid;
0.422 gm/L L-Arginine or a salt thereof;
3.30 gm/L Citric Acid;
26.30 gm/L Sodium Citrate;
0.028 gm/L Adenine;
1.37 gm/L Adenosine;
3.15 gm/L Ribose;
0.88 gm/L L-Citrulline or a salt thereof; and
3.83 gm/L Mannitol.

25. The composition of claim 24, further comprising 0.5 gm/L Potassium phosphate or 0.10 gm/L Magnesium sulfate.

26. A method for preserving fresh red blood cells for a storage period ex vivo comprising contacting said red blood cell with the composition claim 25.

27. The method of claim 26, wherein said storage period is greater than 42 days.

28. The method of claim 26, wherein the red blood cells in storage solution are suitable for direct infusion into a patient in need of such an infusion.

29. A method for processing of fresh red blood cells ex vivo comprising contacting said cells with a first solution comprising
Compounds
Sodium bicarbonate;
Sodium phosphate;
D-Glucose;
Glutathione;
Ascorbic acid;
L-Arginine or a salt thereof;
Citric Acid;
Sodium citrate;
Adenine;
Adenosine;
Ribose;
L-Citrulline or a salt thereof; and
Mannitol;
and then contacting said cells with a second solution comprising
Compounds
L-citrulline or a salt thereof,
L-Arginine or a salt thereof,
Potassium phosphate,
Magnesium chloride,
Magnesium sulfate,
Sodium chloride,
Sodium bicarbonate,
Sodium phosphate.
D-Glucose,
Glutathione,
Ascorbic acid,
Potassium chloride,
Adenine,
Adenosine,
Calcium chloride, and
Ribose.

30. A kit comprising a first blood collection bag comprising a first solution comprising
Compounds
Sodium bicarbonate;
Sodium phosphate;
D-Glucose;
Glutathione;
Ascorbic acid;
L-Arginine or a salt thereof;
Citric Acid;
Sodium citrate;
Adenine;
Adenosine;
Ribose;
L-Citrulline or a salt thereof; and
Mannitol;
and second blood collection bag comprising a second solution, said second solution comprising
Compounds
L-citrulline or a salt thereof,
L-Arginine or a salt thereof,
Potassium phosphate,
Magnesium chloride,
Magnesium sulfate,
Sodium chloride,
Sodium bicarbonate,
Sodium phosphate.
D-Glucose,
Glutathione,
Ascorbic acid,
Potassium chloride,
Adenine,
Adenosine,
Calcium chloride, and
Ribose.
